(19) United States
(12) Patent Application Publication
(10) Pub. No.: US 2009/0288341 A1
(43) Pub. Date: Nov. 26, 2009

(54) BUOYANT PLANT HABITAT AND PROCESS FOR ITS MANUFACTURE

(75) Inventors: Bruce G. Kania, Shepherd, MT (US); Frank M. Stewart, Bozeman, MT (US)

Correspondence Address: ANTOINETTE M. TEASE, P. O. BOX 51016, BILLINGS, MT, 59105, US

(73) Assignee: FOUNTAINHEAD, LLC, Shepherd, MT (US)

(21) Appl. No.: 12/307,584

(22) PCT Filed: Jul. 1, 2007
(86) PCT No.: PCT/US07/72619

§ 371 Date: Jan. 5, 2009

Related U.S. Application Data
(60) Provisional application No. 60/820,341, filed on Jul. 25, 2006.

(51) Int. Cl. A01G 9/02; B29C 44/42; A01G 31/02

(52) U.S. Cl. 47/64; 264/46.5; 264/50; 47/65.7

(57) ABSTRACT

A buoyant plant habitat and a process for manufacturing it. In one embodiment, the invention is a buoyant plant habitat comprising: a nonwoven matrix comprising fibers; and a plurality of buoyant foam units into said nonwoven matrix to produce a buoyant mass; wherein said buoyant foam units envelope a portion of said fibers. In another embodiment, the invention is a process for making a buoyant plant habitat comprising: providing a nonwoven matrix comprising fibers; and injecting a plurality of buoyant foam units into said nonwoven matrix. In another embodiment, the invention is a buoyant plant habitat comprising: a top layer of nonwoven matrix material; a bottom layer of nonwoven matrix material; a plurality of edge pieces of nonwoven matrix material that are attached by means of polymer plugs to said top layer and said bottom layer; and a plurality of closed-cell polymer foam pieces that are disposed between said layers.

### CROSS-REFERENCE TO RELATED APPLICATION

This application claims priority back to U.S. Patent Application No. 60/820,341, filed on 25 Jul. 2006.

### BACKGROUND OF THE INVENTION

This invention relates to floating plant habitats, In particular, the invention relates to a method for manufacturing a floating plant habitat that comprises a nonwoven matrix and a plurality of injected buoyant foam units.

The background art is characterized by U.S. Pat. Nos. 5,224,292; 5,528,856; 5,766,474; 5,980,738; 6,086,755; and 6,555,219 and U.S. Patent Application Nos. 2003/0051398; 2003/0208954; 2005/0183331; the disclosures of which patents and patent applications are incorporated by reference as if fully set forth herein.

Background art floating planters have four major deficiencies that are overcome in preferred embodiments of the present invention. Some background art planters are predominantly covered by materials that prevent or restrict plant growth. For example, the invention described by Tepper (U.S. Pat. No. 6,086,755) comprises a top floatation layer that is manufactured from a conventional buoyant foam such as a foamed plastic. This material is not suitable for plant growth; therefore, this invention requires cutouts to be installed through the foam layer, and plants can only grow through the cutouts. With the Tepper invention, only a portion of the top surface area of the planter is available for plant growth, which reduces the total plant growing capacity of the structure.

Other background art planters use hollow buoyant pipes that are installed around the perimeter of the structure to provide buoyancy. For example, Waterlines Solutions of the U.K. utilizes sealed polypropylene tubes around the perimeter of its floating planters to provide buoyancy. This method of providing buoyancy tends to be fragile (e.g., subject to failure by impact from boats and pressure from freezing ice) and expensive.

Some background art planters require incorporation of additional materials to bond the various layers or components of the planters together. For example, in these planters, buoyant pipes and buoyant top layers must be mechanically attached to the other parts of the structure with cables or adhesives.

Background art floating planters are not designed to be sufficiently large or buoyant to support human traffic. Currently available floating planters are also relatively rigid and do not flex when exposed to waves. Waves are likely to wash over the top of rigid planters, causing damage to growing plants. Moreover, currently available floating planters have uniformly distributed buoyancy and are poorly suited for supporting relatively heavy concentrated loads such as batteries and pumps that may be useful for circulating or aerating water.

All of the instances of background art described above have nonadjustable buoyancy. If the buoyancy of these structures is set to provide the ideal water level for young plants, then the water level may not be optimal when the plants grow and add additional negative buoyancy to the structure. Currently available floating planters are not optimized for producing and/or trapping gases that can provide supplemental buoyancy for the structure.

No examples of background art describe any planting condition other than hydroponic. What is missing is a system that provides a vadose zone with air and other gasses interstitially spaced within it that can extend above the waterline. Instead of being restricted to a hydroponic condition, what is needed is a design that allows for successful cultivation of terrestrial and riparian plants even in a setting where the waterway is not sufficiently aerated to allow for successful cultivation of high oxygen demand terrestrial plants.

### BRIEF SUMMARY OF THE INVENTION

The purpose of a preferred embodiment of the invention is to utilize a fibrous non-woven polyester matrix in combination with injected buoyant (e.g., polyurethane) foam to form a floating island body. In other preferred embodiments, sprayed-on polymer coatings may optionally be applied to selected portions of the top surface of the island. The coatings may be used to provide ultraviolet (UV) protection for the buoyant foam to preserve buoyancy, to provide nesting zones for birds, to trap gases that can provide supplemental buoyancy, and to provide relatively rigid and buoyant walkways for human traffic.

One advantage of preferred embodiments of the invention is that the injected foam buoyancy units can be designed so as not to protrude significantly onto the top growing surface of the structure, thereby providing maximum surface area for plant establishment and growth, when such conditions are desirable. Moreover, the injected foam does not require cutouts within the matrix. It is preferably injected into the matrix and bonds to the matrix fibers, thereby eliminating the requirement for an additional manufacturing operation and providing maximum structural strength of the island body.

The floating island in accordance with this invention may be advantageously designed to be either flexible or rigid, depending on the application. The degree of flexibility can be determined by the diameter of the matrix fibers, the pattern of the injected foam units, and the thickness of the matrix. Flexibility enables preferred embodiments of the island to undulate with wave action. This undulation reduces the tendency for waves to wash over the island surface, thereby minimizing damage to plants. In addition, a flexible island dampens wave amplitude by absorbing and reflecting wave energy. Alternately, the island can be designed to be relatively rigid for applications such as boat docks or floating bridges, where rigidity is desirable for stability. Rigidity also is beneficial for distributing a concentrated top loads over a large surface area, thereby allowing the island to support a relatively heavy concentrated load while maintaining buoyancy over the entire surface area.

Another advantage of preferred embodiments of the invention is that the buoyant components are constructed of non-brittle materials that are protected within the island matrix and are therefore not subject to failure by impact or freezing. This method of construction also makes the present invention less likely to cause boat damage than background art structures with rigid edges. Unlike background art planters with perimeter flotation, the injected foam bodies within the island bodies disclosed herein are protected within the energy-absorbing matrix. Unlike the background art planters with a surface layer of foam flotation, the buoyant units of the present invention are protected from sunlight UV degradation by the surrounding matrix. Furthermore, the injected buoyant foam preferably serves as an adhesive to bond the other materials in the structure together, thereby eliminating a separate manufacturing step to attach the layers or components of the invention.

Another advantage of preferred embodiments of the present invention is that, if the structure requires additional buoyancy during its useful lifetime due to plant growth or other factors, additional buoyancy can be added in-situ at that time by injecting additional uncured foam resin into the matrix. Preferably, these embodiments use foams that can cure underwater. Alternately, cured foam pieces can be added to the underside of the island without removing it from the water.

Yet another advantage is that the present invention does not require separate materials or manufacturing operations to attach the various components together. In some preferred embodiments, the current invention is designed and manufactured to be suitable for human traffic across the entire surface of the island, unlike background art hydroponic systems.

Advantageously, non-woven matrix/injected foam islands are flexible enough to undulate with wave action. This prevents waves from washing over the island surface, thereby minimizing damage to plants. In addition, the floating island in accordance with the invention dampens wave amplitude by absorbing and reflecting wave energy.

The flexible nature of the floating island design provides other advantages. Various portions of the island may selectively be made more or less buoyant; for example, more buoyancy can be provided under a load-bearing object such as a walkway or chair. Moreover, the buoyancy can be precisely adjusted.

Plant roots and insects may optionally be allowed to penetrate the cured foam, resulting in more growing space within the island for plants and animals. In cases where penetration of the foam is not desired, the foam units can be designed to be penetration-resistant, by using a high-density foam and/or a self-skinning foam, or by incorporating a repellent such as capsicum in the foam.

Foam can be injected vertically or horizontally. The entire volume of the matrix can be filled with foam to provide a very buoyant volume of reinforced foam, which may have applications for transporting heavy objects, for example, building floating bridges for temporary vehicle traffic.

Floating islands may be very thin (for example, for large wetland applications in which the square-foot cost must be minimized) to very thick (for example, to grow trees). The islands may be clipped together in order to create larger island units, e.g., using barbed pins that penetrate the foam and matrix.

In some preferred embodiments, a portion of the foam and matrix is submerged, and a portion is disposed above the waterline (i.e., both saturated and vadose-zone growing conditions are created), resulting in a rich and diverse biological environment. Both aerobic and anaerobic zones are produced, thereby aiding the conversion of ammonia to nitrogen gas to reduce dissolved ammonia levels, which can be toxic to fish. In preferred embodiments, nitrification (microbial conversion of ammonia-nitrogen to nitrate-nitrogen) occurs in the aerobic zones and denitrification (microbial conversion of nitrate nitrogen to nitrogen gas) occurs in the anaerobic zones. Preferably, a large percentage of the island surface is “edge habitat,” which promotes a diverse biological community.

The submerged portion of the floating island environment is ideal for gas-producing microbes. The gas produced by these microbes may be used to add buoyancy to islands. The density of the island surface, including matrix and plant bedding material, can be manipulated to enhance the trapping of microbial gasses that aid in buoyancy. Top-coated areas may be made essentially impermeable to gas, thus trapping it even more completely. The impermeable top-coated areas can optionally be fitted with valves to regulate the release of trapped gases beneath the top-coated areas. The valves may be either manual (e.g., ball valves) or automatic (e.g., pressure-relief valves).

In preferred embodiments, the properties of the matrix, such as the fiber diameter and packing density, are designed to prevent the escape of any type of bedding soil from the floating island, while allowing penetration of the floating island by plant roots. In preferred embodiments, top-coated portions of the floating island serve as load-distributing members because they will distribute sources of negative buoyancy (e.g., loads) more evenly across the island's surface.

Thermoplastic foams may alternately be used in place of polyurethane foam to provide adhesion between matrix layers and/or buoyancy for the island. Thermoplastic foams are preferably produced by an extrusion process, wherein plastic pellets are softened by increasing temperature and shear forces within a mechanical extruder. An expansion gas such as compressed iso-butane is injected into the softened plastic within the extruder. The softened plastic exits the extruder in a continuous stream through a nozzle. As the plastic exits the nozzle, the gas within the plastic expands and forms bubbles, producing closed cell foam. The foam cools sufficiently to set within a few seconds after exiting the nozzle. Although extrusion machines typically produce a continuous outlet stream, individual “shots” of foam may be produced by means of a shuttle valve that alternately shunts the stream of soft plastic back and forth between two or more outlets.

In another preferred embodiment, internal buoyancy is integrated within the island body by extruding uncured thermoplastic foam into the porous matrix. Examples of suitable thermoplastic foams include polyethylene, polypropylene and polyester foams. In this embodiment, the thermoplastic material expands and sets around at least some of the fibers of the matrix to form a volume of non-permeable closed cell foam within the island body. The density of the thermoplastic foam may be adjusted by varying the chemical formula of the resin, or by varying the application parameters such as the volume of expansion gas, the extruder temperature, and the extrusion rate. Practical densities of cured thermoplastic foam for the islands range from about 0.5 to about 25.0 pcf. By selecting a thermoplastic resin that has a lower melting temperature than the polyester fibers of the matrix, the molten thermoplastic foam can be injected into the matrix without melting the polyester fibers. For example, a molten polyethylene foam at a temperature of 110 degrees C. can be injected into a polyester matrix that has a melting point of 150 degrees C.

In yet another preferred embodiment, uncured thermoplastic foam is continuously extruded onto a continuous layer of matrix that passes in front of the thermoplastic extrusion nozzle on a moving production line. The thermoplastic foam expands and sets to form a continuous strip of buoyant foam that is bonded to the matrix. The lengths of foamed matrix bodies are preferably cut into individual island shapes in a subsequent manufacturing operation. Optionally, two or more layers of matrix may be stacked with uncured foam introduced between them during the production operation, resulting in a multi-layer matrix with foam between the layers after the foam cures. In this configuration, the foam provides adhesion between joining layers as well as buoyancy.

In a further preferred embodiment, holes or strips are precut into the matrix, and molten thermoplastic foam is extruded into the precut voids, where it expands and sets. This technique may be preferred in cases where injecting the molten foam directly into the matrix results in poor quality foam due to the matrix fibers causing the foam bubbles to break during the expansion process, which could result in a less preferred foam that absorbs water and loses buoyancy.

In another preferred embodiment, pre-manufactured thermoplastic foam cylinders or other prismatic shapes are installed into precut cylindrical or other holes within the matrix, where they are retained by either a friction fit, or by melting. In yet another preferred embodiment, pre-manufactured lengths of extruded foam rods or “noodles” are laid lengthwise between multiple layers of matrix and the assembly is bonded by melting or by means of an adhesive to form a “sandwich” with internal buoyancy provided by the foam noodles.

In another preferred embodiment, relatively small diameter foam noodles are pre-manufactured, and then used to form a buoyant matrix by bonding the noodles together via controlled melting, or by applying suitable adhesive such as latex binder, or by mechanically tangling the fibers to form a nonwoven blanket, or by weaving the fibers to form a woven blanket. Islands made from the buoyant matrix of this embodiment require less additional buoyancy in the form of discrete pieces of buoyant foam, and may be adequately buoyant for some island applications without any additional buoyancy components. The minimum diameter of commercially available noodles is approximately ¼-inch, but smaller diameter noodles (e.g., 0.05 inch) are technically feasible and may be preferred for making buoyant matrix. One example of a manufacturer of ¼ inch diameter polyethylene foam rods is Nomaco Corporation of Zebulon, N.C.

In a further preferred embodiment, small-diameter foam noodles are used as an additive component during the manufacture of nonwoven polyester matrix. The resulting hybrid matrix retains some of the strength properties of the normal polyester matrix, while gaining buoyancy from the foam component. To produce a hybrid matrix material, small-diameter foam noodles are mechanically mixed with raw polyester fibers at a desired blend ratio in a preliminary manufacturing step. The fiber/noodle blend is then fed by hopper into a conventional nonwoven matrix production operation. An example of a conventional nonwoven matrix manufacturer is Americo Manufacturing Company, Inc. of Acworth, Ga.

Multi-layer islands may be fabricated so as to incorporate pieces of closed cell foam in the interior portion of the islands. In this embodiment, the pieces of closed cell foam provide a durable and low cost means of providing a portion of the island's buoyancy. The closed cell foam may be comprised of any suitable polymer foam material such as polyethylene, polypropylene, polyester, or polyurethane. Scrap pieces of foam material may be used in the island interior. This “sandwich” method of island construction results in a relatively thick, easily-constructed product. Thick islands may be preferable to thin islands in some applications; for example, in applications in which water is circulated through the interior of an island for biological filtration, or in applications where massive or tall plants are grown in an island.

In a preferred embodiment, the invention is a process for making a buoyant plant habitat comprising: providing a nonwoven matrix having a surface and comprising fibers; and injecting a plurality of buoyant foam units into said nonwoven matrix to produce a buoyant mass; wherein said buoyant foam units envelope a portion of said fibers. Preferably, the process further comprises planting a plurality of plants in said nonwoven matrix, and placing said buoyant mass in a body of water. Preferably, the process further comprises: applying a latex binder to said fibers. Preferably, said injecting step further comprises: injecting an uncured polyurethane resin under pressure into said nonwoven matrix through said surface. Preferably, said surface is selected from the group consisting of a top surface, a side surface and a bottom surface. Preferably, an approximately four-second shot of uncured foam is injected with a pressure of approximately 70 pounds per square inch, resulting in a cured mass of foam that is approximately spherical in shape, having a diameter of approximately 8 inches. Preferably, said buoyant units are coated with a sprayed-on polymer outer covering to increase durability.

In another embodiment, the process further comprises: applying a substantially rigid top cover to a portion of said buoyant mass. Preferably, said substantially rigid top cover comprises: a foam under layer; and a substantially rigid polymer top coating. Preferably, the process further comprises: embedding an aggregate in said substantially rigid polymer top coating. Preferably, said substantially rigid polymer is polyurethane, polyurea, or silicone. Preferably, said surface is a top surface and said process further comprises: constructing a rigid walkway across the top surface of buoyant mass by first spraying on a rapid-setting, two-part polyurethane resin that cures into a foam layer that extends approximately one inch into the top surface and that is nonporous to bubbles; and spraying on a two-part polyurea resin that cures in place on top of the foam layer to form a rigid and durable surface coat. Preferably, the process further comprises: adding a dye or pigment to the surface coat to provide the desired color and to increase the ultraviolet light resistance of said surface coat and the underlying foam layer. Preferably, the process further comprises: attaching aggregate or sand to said top coat by sprinkling it onto said top coat while the top coat is in an uncured, tacky state, and allowing said aggregate or sand to bond to said top coat during curing.

In yet another embodiment, the invention is a buoyant plant habitat comprising: a nonwoven matrix having a top surface and comprising fibers; and a plurality of buoyant foam units into said nonwoven matrix to produce a buoyant mass; wherein said buoyant foam units are comprised of an expanded, cured polyurethane resin that envelopes a portion of said fibers to produce foamed zones. Preferably, said foamed zones are approximately spherical in shape. Preferably, said buoyant units are coated with a sprayed-on polymer outer covering. Preferably, the buoyant plant habitat farther comprises: a rigid walkway disposed across the top surface of said buoyant mass that comprises a foam layer that extends into said top surface. Preferably, the buoyant plant habitat further comprises: a rigid and durable surface coat on said foam layer. Preferably, said surface coat comprises a dye or pigment that is capable of imparting a color to said surface coat and increasing the ultraviolet resistance of said surface coat. Preferably, the buoyant plant habitat of further comprises: aggregate or sand that is bonded to said top coat.

In another preferred embodiment, the invention is a process for manufacturing a buoyant plant habitat, said process comprising: adding an expansion gas to a molten resin having a temperature to produce an uncured foam; depositing said uncured foam between an upper matrix sheet and a lower matrix sheet, each of said upper and lower matrix sheets comprising fibers having a melting point; and pressing said upper matrix sheet and said lower matrix sheet together, thereby forcing said uncured foam into at least a portion of said upper matrix sheet and said lower matrix sheet; allowing said uncured foam to cure in place producing a bonded multi-layer matrix composite. Preferably, said adding step comprises adding iso-butane gas to said molten resin. Preferably, said molten resin is selected from the group consisting of polyethylene, polypropylene and polyester. Preferably, said temperature is lower than said melting point.

Preferably, the process further comprises: depositing said uncured foam between an upper matrix sheet and a lower matrix sheet with an extruder having a nozzle by which said upper matrix sheet and a lower matrix sheet are substantially continuously moved. Preferably, the process further comprises: cutting a hole in said upper matrix sheet and/or a lower matrix sheet and extruding said uncured foam into said hole.

In yet another preferred embodiment, the invention is a process for manufacturing a buoyant plant habitat, said process comprising: cutting a hole in a matrix sheet, said matrix sheet comprising a nonwoven blanket; depositing a pre-manufactured thermoplastic foam body in said hole; and retaining said pre-manufactured thermoplastic foam body in said hole by friction fit or by melting. In another preferred embodiment, the invention is a process for manufacturing a buoyant plant habitat, said process comprising: providing a plurality of layers of matrix material; depositing extruded foam rods between each pair of said layers to produce an assembly; and bonding the components of said assembly together to produce a sandwich with internal buoyancy provided by said extruded foam rods. Preferably, said depositing step involves depositing foam noodles. In another preferred embodiment, the invention is a process for manufacturing a buoyant plant habitat, said process comprising: adding a plurality of small-diameter noodles to a plurality of polyester fibers to produce a two-component feed material; and forming said feed material into a hybrid matrix material.

In a further preferred embodiment, the invention is a buoyant plant habitat comprising: a top layer of nonwoven matrix material; a bottom layer of nonwoven matrix material; a plurality of edge pieces of nonwoven matrix material that are attached by means of closed-cell polymer plugs to said top layer and said bottom layer; and a plurality of closed-cell polymer foam pieces that are disposed between said top layer and said bottom layer. Preferably, the buoyant plant habitat further comprises: a plurality of interior foam bodies that are disposed between said top layer and said bottom layer. Preferably, the buoyant plant habitat further comprises: a plant growth medium that is disposed between said top layer and said bottom layer.

In groundwater hydrology, the zones of the subsurface that contain water are divided into the “saturated zone” and the unsaturated or “vadose zone.” The saturated zone is the area of the subsurface that lies at or below the water table. For example, when a well is drilled into the saturated zone, the level of standing water in the well is equivalent to the level of the water table.

The vadose zone is the portion of the subsurface that contains some water but is not saturated with water. The pore spaces between the soil or rock particles in the vadose zone contain a combination of water and air. Vadose zone water (or “vadose water”) is held in place by hydroscopic and capillary forces. The maximum amount of water that can be held in a particular vadose zone is a function of the particle size and shape of the soil or bedding medium or other materials within the zone, and of the gasses trapped within the zone. Excess water that enters the vadose zone (for example, from rainfall) normally drains by gravity through the vadose zone down to the saturated zone. Terrestrial plants have evolved to thrive in the vadose zone, as they require a growth medium in which their roots can uptake both water and air. Aquatic plants, in contrast, have evolved to thrive in the saturated zone; these plants do not need air-filled pore spaces around their roots.

In describing preferred floating island embodiments, applicants use the term “saturated zone” to describe the portion of the island body whose pore spaces are completely filled with water.

The vadose zone in a floating island may be supplied by water from the top down, for example, by rainfall. In addition, the vadose zone in a floating island may be supplied with water from the bottom up, via capillary action. Since this “bi-directional” water supply capability of the floating islands disclosed herein is different from the “top-down only” water supply in conventional agricultural vadose zones, applicants have coined the term “bi-vadose” zone to define the unsaturated zone within the floating islands disclosed herein. The bi-vadose zone comprises the moist portion of the island body that is above the saturated zone. In the bi-vadose zone, the pore spaces within the island body contain a mixture of air and water. The bi-vadose zone does not become saturated with water because any excess water that enters this zone drains down through the fibers by gravity or may evaporate at the surface of the island.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention.

FIG. 1 is a top plan view of a floating island comprising an injected foam unit for buoyancy in accordance with a preferred embodiment of the invention.

FIG. 2 is a side (elevation) cross-sectional view of the embodiment of the floating island shown in FIG. 1.

FIG. 3 is a top plan view of a preferred embodiment of a floating island that incorporates zones of a rigid stepping stone top cover.

FIG. 4 is a side (elevation) cross-sectional view of the preferred embodiment of floating island of FIG. 3.

FIG. 5 is a magnified schematic view of a portion of the floating island of FIG. 4 that shows the details of a first preferred embodiment of a top cover.

FIG. 6 is a cross-section side (elevation) view of a floating island with another preferred embodiment of a rigid top cover.

FIG. 7 is a magnified schematic view of a portion of the floating island of FIG. 6 that shows the details of a second preferred embodiment of the rigid top cover.

FIG. 8 is a schematic diagram of the process of manufacturing another preferred embodiment of a floating island in accordance with the invention.

FIG. 9 is a cross-section side (elevation) view of a floating island comprising closed cell foam pieces in accordance with a preferred embodiment of the invention.

The following reference numerals are used to indicate the parts and environment of the invention on the drawings:
1 nonwoven matrix, porous matrix, matrix
2 buoyant foam units, buoyant polyurethane foam units
3 growing plants, plants
4 rigid top cover
6 foam under layer
7 rigid polymer top coating, top coating
8 embedded aggregate, sand
9 gas bubbles, bubbles
20 floating island, buoyant island
22 water
24 waterline
26 top surface
28 side surface
30 bottom surface
32 thermoplastic foam pieces, closed-cell foam pieces, polymer foam pieces
34 uncured thermoplastic foam, uncured foam
36 nozzle
38 extruder
40 compressed foaming gas, expansion gas
42 internal bubbles
44 upper matrix sheet
46 lower matrix sheet
48 arrows
50 rollers
52 matrix composite
54 top layer
56 bottom layer
58 edge pieces
60 closed-cell polymer foam plugs, foam plugs
62 interior portion
64 nonwoven polymer matrix pieces
66 interior foam bodies

### DETAILED DESCRIPTION OF THE INVENTION

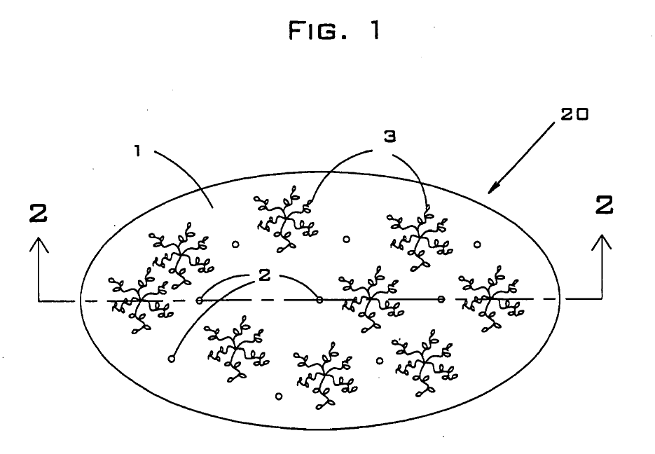

Referring to FIG. 1, a preferred embodiment of floating island or buoyant plant habitat 20 is presented. In this embodiment, floating island 20 comprising nonwoven matrix 1, buoyant polyurethane foam units 2 and plants 3. Preferably, buoyant units 2 are manufactured by injecting uncured liquid polyurethane resin under pressure through top surface 26 of porous matrix 1. The polyurethane resin is then allowed to expand and cure in place within matrix 1. The injection pressure, resin temperature, and injection shot volume of the foam injection machine (not shown) are preferably preset so as to provide the desired final volume of cured buoyant foam in each one of the buoyant units 2. In preferred embodiments, the polyurethane resin is injected through the top, sides, or bottom of the floating island 20, or through a combination of these surfaces, depending on the particular application of the island.

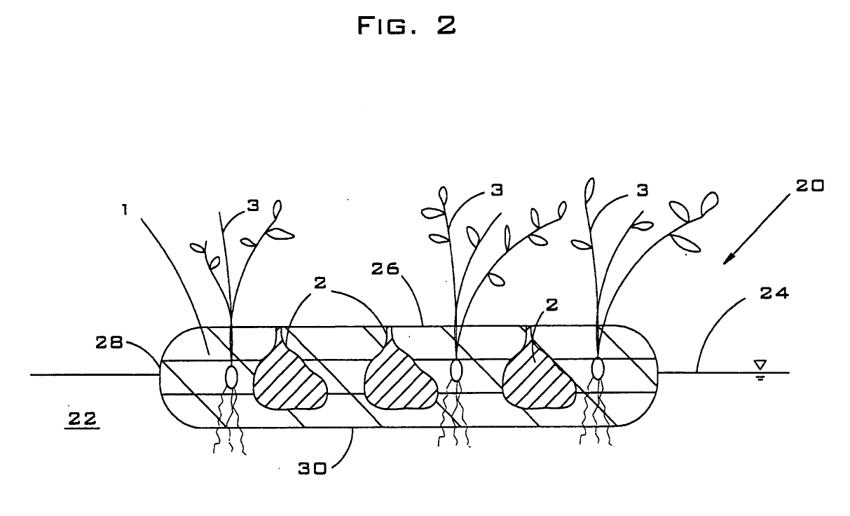

Referring to FIG. 2, a side (elevation) cross-sectional view of the embodiment of the floating island shown in FIG. 1 is presented. In this view, the placement of buoyant foam units 2 in floating island 20 is shown. In this embodiment, matrix 1 is comprised of polyester fibers that are intertwined to form a randomly oriented web or “blanket,” preferably with a standard thickness and width. While small islands 20 can be made of a single piece and thickness of matrix, the dimensions of a larger island body are set by attaching multiple pieces of matrix 1 side-by-side and/or vertically. In one preferred embodiment, matrix 1 is comprised of 200-denier polyester fibers that are intertwined to form a blanket approximately 1¾ inch thick by 56 inches wide.

Preferably, matrix 1 is produced in a continuous strip and cut to lengths of approximately 90 feet for shipping. The nominal weight of the blanket is preferably 41 ounces per square yard. The nominal weight of the polyester fibers within the blanket is preferably 26 ounces per square yard. A water-based latex binder is preferably baked onto the fibers to increase the stiffness and durability of the blanket. The characteristics of matrix 1 can be adjusted by varying the construction materials and manufacturing process. For example, the diameter of the fibers may be varied from approximately 6 to 300 denier. Coarse fibers result in a relatively stiff matrix with relatively small surface area for colonizing microbes, and fine fibers result in a relatively flexible matrix with a relatively large surface area for colonizing microbes. The latex binder can be applied relatively lightly or relatively heavily to vary the durability and weight of the matrix, and dye or pigment can be added to the binder to produce a specific color of matrix.

The thickness of the blanket can be adjusted from approximately ¼-inch to 2 inches using conventional manufacturing techniques. It is anticipated that thicker blankets will be produced in the future, and these thicker blankets (for example, 3 to 12 inches) will be used as island body material when they become available. The blankets with integral latex binder may be purchased as a manufactured item. One manufacturer of suitable matrix material is Americo Manufacturing Company, Inc. of Acworth, Ga.

In a preferred embodiment, internal buoyancy is integrated within island body 20 by injecting uncured liquid polyurethane resin under pressure into porous matrix 1. The polyurethane resin then expands and cures in place within matrix 1. The injection pressure, resin temperature, and injection shot volume of the foam injection machine are preferably preset so as to provide the desired final volume of cured buoyant foam. The foam may be installed so as to provide a continuous volume throughout matrix 1, or alternately, it may be installed so as to provide individual buoyant sections (units) of foam within matrix 1 that are separated by non-foamed zones of matrix 1. The polyurethane resin can be injected from the top, sides, or bottom of the island, or from a combination of these surfaces, depending on the particular application of the island. In one preferred embodiment, matrix 1 is constructed so as to have a thickness of approximately 8 inches. Uncured foam resin having a nominal cured density of 2.5 pounds per cubic foot (pcf) is injected into the bottom of the matrix, and penetrates to top surface 26 of matrix 1. An approximately four-second shot of uncured foam is injected with a pressure of approximately 70 pounds per square inch, resulting in a cured mass of foam that is approximately spherical in shape, having a diameter of approximately 8 inches. The sphere has a density of approximately 5.8 pcf, consisting of approximately 2.5 pcf polyurethane foam that is reinforced with matrix having a density of approximately 3.3 pcf. The density of the polyurethane foam can be adjusted by varying the chemical formula of the resin, or by varying the application parameters, such as temperature and pressure. Practical ranges of foams for the islands range from about 1.0 to 25.0 pcf. The lighter foams are desirable where high buoyancy and low cost are important, for example, for decorative water garden islands. The heavier density foams are preferable where high strength and durability are important, for example, where the islands may be subjected to boat impacts. The foamed zones of matrix 1 may be optionally coated with a spray-on polymer outer covering to increase durability.

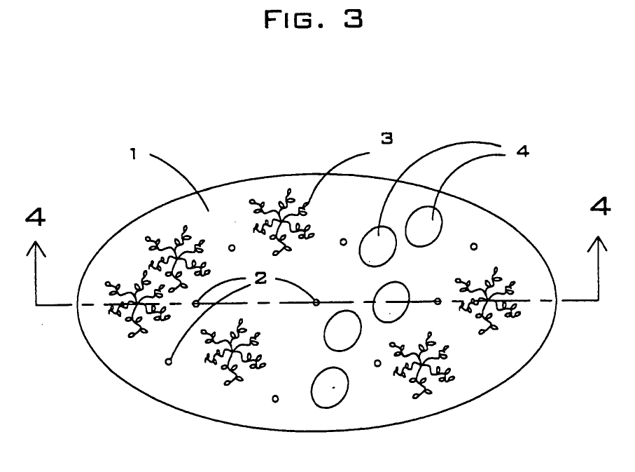

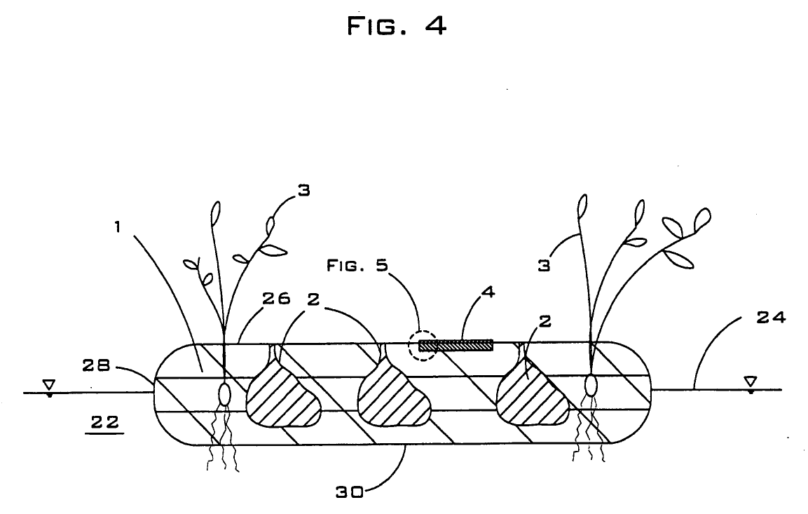

Referring to FIG. 3, a preferred embodiment of a floating island that incorporates zones of a rigid top cover is presented. FIG. 4 presented a cross-sectional view of the preferred embodiment of floating island of FIG. 3. In these views, rigid top cover 4 comprises a plurality of individual artificial “stepping stones” used to support human traffic. The stepping stones allow access to plants 3.

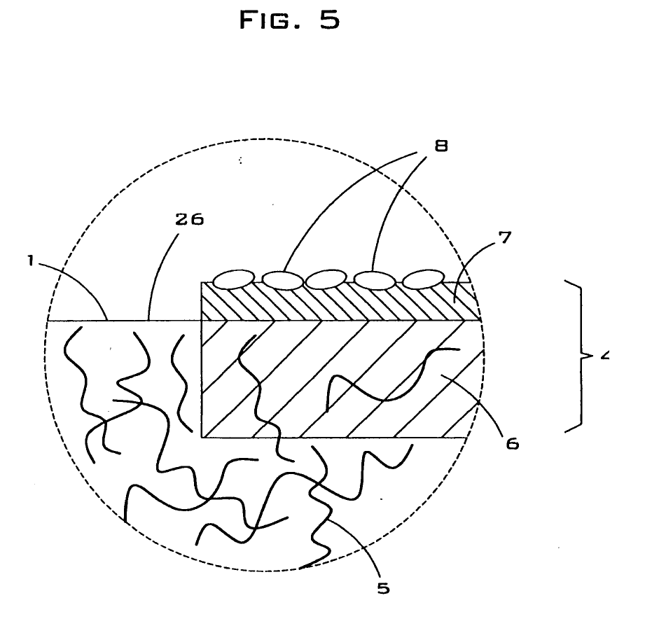

FIG. 5 is a magnified schematic view of a portion of the floating island of FIG. 4 that shows the details of a preferred embodiment of substantially rigid top cover 4. In this embodiment, rigid top cover 4 comprises foam under layer 6, substantially rigid polymer top coating 7, and, optionally embedded aggregate 8. As shown in FIG. 5, foam under layer 6 is preferably positioned within matrix 1, while top coating 7 extends above top surface 26 of matrix 1. Optional embedded aggregate 8 is preferably bonded into top coating 7 during the curing process.

Top coatings may be comprised of any durable spray-applied polymer such as polyurethane, polyurea, or silicone. The spray coatings are optionally underlain with a relatively thin layer of polyurethane foam. The preferred range of thickness for the foam under layer is approximately ½ inch to 6 inches. The preferred range of thickness for the top coating 7 is approximately 0.005 to 0.5 inches.

In one preferred embodiment, a rigid walkway is constructed across top surface 26 of island 20 by first spraying on a rapid-setting, two-part polyurethane resin that cures into a foam layer that extends approximately one inch into top surface 26 of nonwoven matrix 1. The second step consists of spraying on a two-part polyurea resin that cures in place on top of the foam layer to form a ¼-inch thick rigid and durable surface coat. Dye or pigment is added to the surface coat to provide the desired color and to increase the ultraviolet (UV) sunlight resistance of the material and the underlying foam. Aggregate or sand 8 may optionally be attached to the top coating 7 by introducing it onto the uncured tacky top coating 7, and allowing it to bond during curing. The aggregate or sand may be used to provide a non-slip walking surface, or to attach nesting gravel for certain birds such as plovers, or for other purposes. Alternately, granular particles may be added to the resin prior to spraying in order to provide a non-slip surface, or the surface may be mechanically roughened with a wire brush or similar tool after curing.

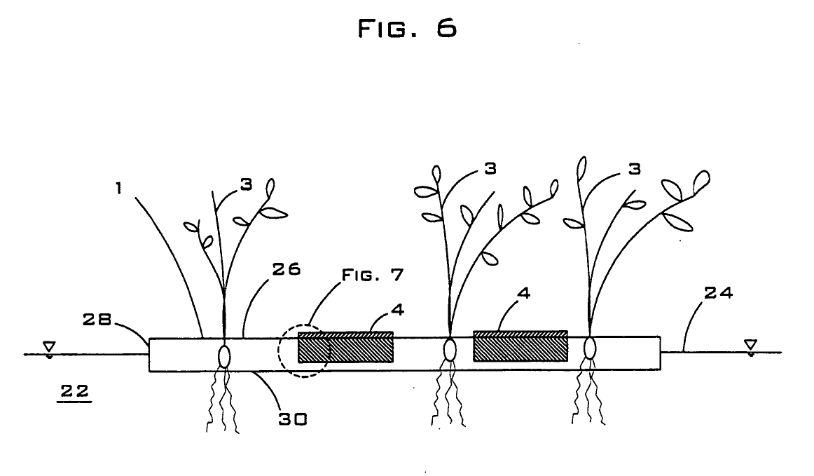

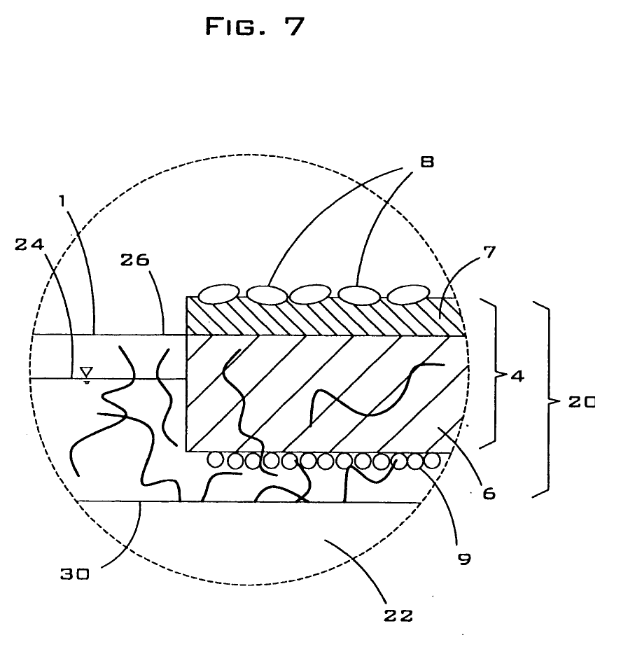

Referring to FIG. 6, a cross-section side (elevation) view of floating island 20 with another preferred embodiment of rigid top cover. FIG. 7 is a magnified schematic view of a portion of the floating island of FIG. 6. In this embodiment, matrix 1 is relatively thin, and rigid top cover 4 is designed to be thick enough to provide buoyancy for the island that contains growing plants 3.

As shown in FIG. 7, in this embodiment, foam under layer 6 is positioned within matrix 1, while top coating 7 extends above top surface 26 of matrix 1. Optional embedded aggregate 8 is bonded into top coating 7 during the curing process. In the embodiment shown in FIG. 7, buoyancy of floating island 20 is partially supplied by the submerged portion of foam under layer 6, and additional buoyancy is supplied by trapped gas bubbles 9. Gas bubbles 9 may result from microbial activity within matrix 1, or from microbial activity in the water body below island 20, or from mechanically injected air from an aerator (not shown) that releases bubbles into water 22 below island 20. Bubbles 9 rise through porous matrix 1 of island 20 until they are stopped by foam under layer 6, which is preferably nonporous.

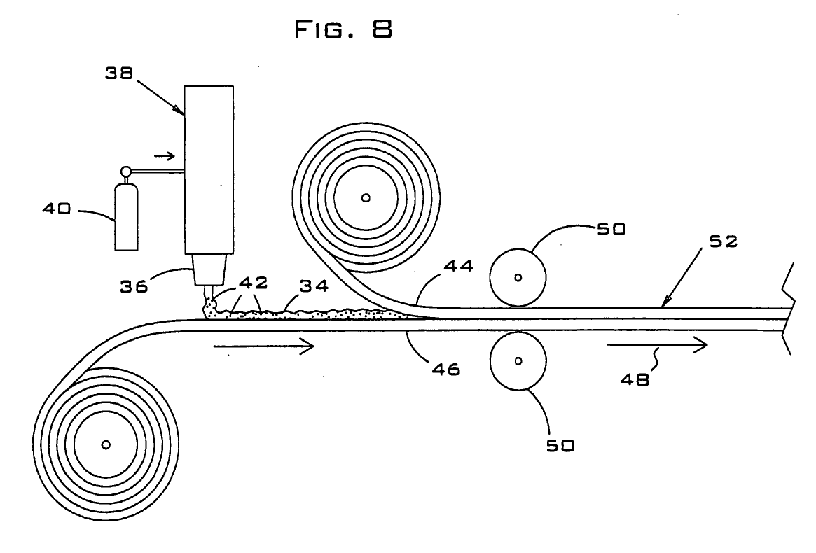

In another preferred embodiment, floating island 20 contains one or more continuous strips of thermoplastic foam. A preferred embodiment of a process for installing thermoplastic foam into matrix 1 is shown schematically in FIG. 8. Uncured thermoplastic foam 34 is extruded through nozzle 36 of extruder 38. Compressed foaming gas 40 is added to the molten resin inside extruder 38, producing internal bubbles 42 in uncured foam 34. Uncured foam 34 is deposited as a continuous strip between upper matrix sheet 44 and lower matrix sheet 46, which are moving continuously in the direction shown by arrow 48. Rollers 50 press upper and lower matrix sheets 44 and 46 together, thereby forcing uncured foam 34 into the fibers of matrix sheets 44 and 46. Uncured foam 34 expands and cures in place, thereby producing a bonded multi-layer matrix composite 52 comprising one or more continuous strips of thermoplastic foam (not shown). Although FIG. 8 depicts the application of a single strip of continuous foam, multiple continuous strips of thermoplastic foam may be installed into the matrix by placing additional extruders so that they extrude parallel strips of uncured foam onto the matrix.

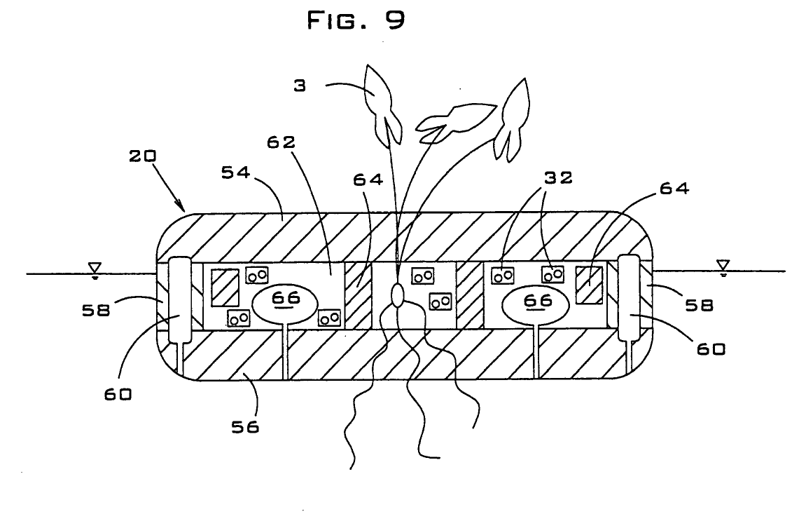

An island comprising closed-cell foam pieces 32 is shown schematically in FIG. 9 in a side cross section view. The outer section of island 20 is comprised of a top layer 54 of nonwoven polymer matrix, bottom layer 56 of nonwoven polymer matrix, and edge pieces 58 of nonwoven polymer matrix. These matrix pieces 54, 56 and 58 are bonded by injecting closed-cell polymer foam plugs 60 into the matrix around the edges of island 20. In addition to bonding the layers, foam plugs 60 also add buoyancy to the outer perimeter of island 20.

In this embodiment, interior portion 62 of island 20 is filled with closed-cell polymer foam pieces 32, and optional nonwoven polymer matrix pieces 64. Interior polymer foam bodies 66 may optionally be injected into interior portion 62 of island 20 to provide buoyancy and to bond together polymer foam pieces 32 and nonwoven matrix pieces 64. In this embodiment, the roots of plants 3 grow into and between the pieces 32, 64 and may penetrate through the sides and bottom of island 20. An optional plant growth medium (not shown) such as peat or bedding soil may be added to interior portion 62 of island 20 to promote plant growth. Plants 3 may also be grown in bedding pockets (not shown) that are installed in top layer 54 of island 20.

In an alternate embodiment, foam is installed vertically through the matrix. The foam may either fully penetrate the matrix from top to bottom, or it may only partially penetrate the matrix. In this embodiment, a precut hole or void is constructed so that it penetrates the entire matrix vertically from bottom to top or so that it only partially penetrates the matrix (for example, the void or hole may penetrate the bottom surface of the matrix and terminate at a location within the interior of the matrix). In the former case, the foam that is installed into the void or hole will extend completely from the bottom to the top of the matrix; in the latter case, the foam that is installed in the void or hole will extend to the bottom surface of the matrix but will not extend to the top surface of the matrix.

Many variations of the invention will occur to those skilled in the art. Some variations include a top coating. Other variations call for a flexible island body. All such variations are intended to be within the scope and spirit of the invention.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of the invention.

What is claimed is:

1. A process for making a buoyant plant habitat comprising:
providing a nonwoven matrix having a surface and comprising fibers; and
injecting a plurality of buoyant foam units into said nonwoven matrix to produce a buoyant mass;
wherein said buoyant foam units envelope a portion of said fibers.

2. The process of claim 1, further comprising:
planting a plurality of plants in said nonwoven matrix, and
placing said buoyant mass in a body of water.

3. The process of claim 1, further comprising:
applying a latex binder to said fibers.

4. The process of claim 1, wherein said injecting step further comprises:
injecting an uncured polyurethane resin under pressure into said nonwoven matrix through said surface.

5. The process of claim 4, wherein said surface is selected from the group consisting of a top surface, a side surface and a bottom surface.

6. The process of claim 4, wherein an approximately four-second shot of uncured foam is injected with a pressure of approximately 70 pounds per square inch, resulting in a cured mass of foam that is approximately spherical in shape, having a diameter of approximately 8 inches.

7. The process of claim 1, wherein said buoyant units are coated with a sprayed-on polymer outer covering to increase durability.

8. The process of claim 1, further comprising:
applying a substantially rigid top cover to a portion of said buoyant mass.

9. The process of claim 1, wherein said substantially rigid top cover comprises:
a foam under layer; and
a substantially rigid polymer top coating.

10. The process of claim 9, further comprising:
embedding an aggregate in said substantially rigid polymer top coating.

11. The process of claim 9, wherein said substantially rigid polymer is polyurethane, polyurea, or silicone.

12. The process of claim 1, wherein said surface is a top surface and wherein said process further comprises:
constructing a rigid walkway across the top surface of buoyant mass by first spraying on a rapid-setting, two-part polyurethane resin that cures into a foam layer that extends approximately one inch into the top surface and that is nonporous to bubbles; and
spraying on a two-part polyurea resin that cures in place on top of the foam layer to form a rigid and durable surface coat.

13. The process of claim 12, further comprising:
adding a dye or pigment to the surface coat to provide the desired color and to increase the ultraviolet light resistance of said surface coat and the underlying foam layer.

14. The process of claim 13, further comprising:
attaching aggregate or sand to said top coat by sprinkling it onto said top coat while the top coat is in an uncured, tacky state, and allowing said aggregate or sand to bond to said top coat during curing.

15. A process for manufacturing a buoyant plant habitat, said process comprising:
adding an expansion gas to a molten resin having a temperature to produce an uncured foam;
depositing said uncured foam as at least one strip between an upper matrix sheet and a lower matrix sheet, each of said upper and lower matrix sheets comprising fibers having a melting point; and
pressing said upper matrix sheet and said lower matrix sheet together, thereby forcing said uncured foam into at least a portion of said upper matrix sheet and said lower matrix sheet;
allowing said uncured foam to cure in place producing a bonded multi-layer matrix composite.

16. The process of claim 15, wherein said adding step comprises adding iso-butane gas to said molten resin.

17. The process of claim 15, wherein said molten resin is selected from the group consisting of polyethylene, polypropylene and polyester.

18. The process of claim 15, wherein said temperature is lower than said melting point.

19. The process of claim 15, further comprising:
depositing said uncured foam between an upper matrix sheet and a lower matrix sheet with an extruder having a nozzle by which said upper matrix sheet and a lower matrix sheet are substantially continuously moved.

20. The process of claim 15, further comprising:
cutting a hole in said upper matrix sheet and/or a lower matrix sheet and extruding said uncured foam into said hole.

21. A process for manufacturing a buoyant plant habitat, said process comprising:
cutting a hole in a matrix sheet, said matrix sheet comprising a nonwoven blanket;
depositing a pre-manufactured thermoplastic foam body in said hole; and
retaining said pre-manufactured thermoplastic foam body in said hole by friction fit or by melting.

22. A process for manufacturing a buoyant plant habitat, said process comprising:
providing a plurality of layers of matrix material;
depositing a plurality of extruded foam rods between each pair of said layers to produce an assembly; and
bonding the components of said assembly together to produce a sandwich with internal buoyancy provided by said extruded foam rods.

23. The process of claim 22, wherein said depositing step involves depositing foam noodles.

24. A process for manufacturing a buoyant plant habitat, said process comprising:
adding a plurality of small-diameter noodles to a plurality of polyester fibers to produce a two-component feed material; and
forming said feed material into a hybrid matrix material.

25. A process for manufacturing a buoyant plant habitat, said process comprising:
providing one or more layers of nonwoven matrix material and placing such layers adjacent to one another vertically;
cutting a hole through one or more adjacent layers of matrix; and
extruding uncured foam into said hole and allowing said foam to cure.

26. The process of claim 25, wherein the buoyant plant habitat comprises a top-most layer of matrix and a bottom-most layer of matrix,
wherein the top-most layer of matrix comprises a top surface,
wherein the bottom-most layer of matrix comprises a bottom surface, and
wherein the foam extends from the top surface of the top-most layer of matrix to the bottom surface of the bottom-most layer of matrix.

27. The process of claim 25, wherein the buoyant plant habitat comprises a top-most layer of matrix and a bottom-most layer of matrix,
wherein the top-most layer of matrix comprises a top surface,
wherein the bottom-most layer of matrix comprises a bottom surface, and
wherein the foam extends from the bottom surface of the bottom-most layer of matrix to a point that falls short of the top surface of the top-most layer of matrix.

28. The process of claim 25, wherein the buoyant plant habitat comprises a top-most layer of matrix and a bottom-most layer of matrix,
wherein the top-most layer of matrix comprises a top surface,
wherein the bottom-most layer of matrix comprises a bottom surface, and
wherein the foam extends from the top surface of the top-most layer of matrix to a point that falls short of the bottom surface of the bottom-most layer of matrix.

29. A buoyant plant habitat comprising:
a nonwoven matrix having a top surface and comprising fibers; and
a plurality of buoyant foam units into said nonwoven matrix to produce a buoyant mass;
wherein said buoyant foam units are comprised of an expanded, cured polyurethane resin that envelopes a portion of said fibers to produce foamed zones.

30. The buoyant plant habitat of claim 29, wherein said foamed zones are approximately spherical in shape.

31. The buoyant plant habitat of claim 30, wherein said buoyant units are coated with a sprayed-on polymer outer covering.

32. The buoyant plant habitat of claim 29, further comprising:
a rigid walkway disposed across the top surface of said buoyant mass that comprises a foam layer that extends into said top surface.

33. The buoyant plant habitat of claim 31, further comprising:
a rigid and durable surface coat on said foam layer.

34. The buoyant plant habitat of claim 31, wherein said surface coat comprises a dye or pigment that is capable of imparting a color to said surface coat and increasing the ultraviolet resistance of said surface coat.

35. The buoyant plant habitat of claim 34, further comprising:
aggregate or sand that is bonded to said top coat.

36. A buoyant plant habitat comprising:
a top layer of nonwoven matrix material;
a bottom layer of nonwoven matrix material;
a plurality of edge pieces of nonwoven matrix material that are attached by means of closed-cell polymer plugs to said top layer and said bottom layer; and
a plurality of closed-cell polymer foam pieces that are disposed between said top layer and said bottom layer.

37. The buoyant plant habitat of claim 36, further comprising:
a plurality of interior foam bodies that are disposed between said top layer and said bottom layer.

38. The buoyant plant habitat of claim 36, further comprising:
a plant growth medium that is disposed between said top layer and said bottom layer.

39. The buoyant plant habitat of claim 36, wherein said nonwoven matrix material comprises a hybrid matrix material.
